(19) United States
(12) Patent Application Publication
(10) Pub. No.: US 2011/0276346 A1
(43) Pub. Date: Nov. 10, 2011

(54) AUTOMATED METHOD FOR MEDICAL QUALITY ASSURANCE

(76) Inventor: Bruce Reiner, Berlin, MD (US)

(21) Appl. No.: 12/998,557

(22) PCT Filed: Nov. 3, 2009
(86) PCT No.: PCT/US2009/005939

§ 371 Date: Jul. 27, 2011

Related U.S. Application Data
(60) Provisional application No. 61/193,179, filed on Nov. 3, 2008.

(51) Int. Cl. G06Q 50/00

(52) U.S. Cl. 705/3; 705/2

(57) ABSTRACT

The present invention relates to an automated method for quality assurance (QA) which creates quality-centric data contained within a medical report, and uses these data elements to determine report accuracy and correlation with clinical outcomes. In addition to a QA report analysis, the present invention also provides an automated mechanism to customize report content base upon end-user preferences and QA feedback. In one embodiment, a computer-implemented method of automated medical QA includes storing QA data and supportive data in at least one database; identifying a QA discrepancy from QA data; assigning a level of clinical severity, to the QA discrepancy; creating an automated differential diagnosis based on the level of clinical severity, to determine clinical outcomes; and analyzing the QA data and correlating the analysis of the QA data with stored supportive data and clinical outcomes.

### CROSS-REFERENCE TO RELATED APPLICATIONS

The present invention claims priority from U.S. Provisional Patent Application No. 61/193,179, dated Nov. 3, 2008, the contents of which are herein incorporated by reference in their entirety.

### BACKGROUND OF THE INVENTION

1. Field of the Invention

The automated method for Quality Assurance (QA) of the present invention creates quality-centric data contained within a medical report, and uses these data elements to determine report accuracy and correlation with clinical outcomes. The present invention also provides a mechanism to enhance end-user education, communication between healthcare providers, categorization of QA deficiencies, and the ability to perform meta-analysis over large end-user populations. In addition to a QA report analysis, the present invention also provides an automated mechanism to customize report content base upon end-user preferences and QA feedback.

2. Background of the Invention

The concept of automating and quantifying quality assurance (QA) in medical imaging has been previously discussed in U.S. patent application Ser. Nos. 11/412,884, filed Apr. 28, 2006, and 11/699,348, 11/699,349, 11/699,350, 11/699,344, and 11/699,351, all filed Jan. 30, 2007, the contents of which are herein incorporated by reference in their entirety. In U.S. patent application Ser. No. 11/412,884, software algorithms were developed to objectively quantify QA deficiencies in the medical image acquisition, and create structured QA data elements which would be entered into a QA database for analysis and decision support.

In U.S. patent application Ser. Nos. 11/699,348, 11/699,349, 11/699,350, 11/699,344, and 11/699,351, quantifiable quality-oriented metrics were created to measure quality performance throughout the imaging chain and provide an objective QA structured database for comparative analysis.

In its current form, QA in medical imaging is often arbitrary, idiosyncratic, and inconsistent. With the exception of mammography, few QA standards exist within medical imaging which rigorously defines and quantifies quality-oriented metrics. As a result, most medical imaging practitioners practice QA in a manner which satisfies the minimum standards set forth by the Joint Commission on the Accreditation of Healthcare Organizations (JCAHO) and the American College of Radiology (ACR). These standards are largely devised to appeal to the “lowest common denominator”, and are primarily focused on image acquisition and patient safety concerns. The content, structure, and overall accuracy of the medical report are largely left to the discretion and review of the individual practitioner and medical department. As a result, few objective standards and metrics exist for quantifying quality within the medical report, and providing educational and constructive feedback to the authoring physician.

Thus, when reviewing reporting quality assurance (report QA) in a medical imaging practice, large inter-practice variability exists. This QA variability is multi-factorial in nature and can in part be due to practice type, technology utilized, resource allocation, and clinical expectations. Examples of the existing QA variability can be illustrated in the two examples described below.

In the first example, a conventional hospital-based medical imaging department performs report QA in a manual fashion, with the stated purpose of meeting JCAHO requirements. This entails a documented radiologist peer review program where randomly selected radiology reports are reviewed by in-department colleagues, with the goal of quantifying the frequency and severity of QA discrepancies. A number of inherent limitations and variability problems exist with this type of “internal” QA program.

For example, with internal QA (e.g., hospital imaging department), issues include: a) an extremely small sample size of reports is analyzed (i.e., typically <5% of all reports generated); b) retrospective analysis (by affiliated readers) is required (often performed weeks after the initial report was generated; c) there is peer pressure to minimize the number and severity of the reported discrepancies; d) the need for proactive follow-up (often not performed); and e) there is minimal integration with non-radiology data (i.e., lack of integration with clinical (i.e., non-imaging) data elements).

At the opposite QA extreme (external QA), is the teleradiology practice, in which imaging reports are generated by an “external” service provider, who typically has no direct ties to the institution where patient care takes place. In this “external” scenario, a number of marked QA differences exist, resulting in a far greater degree of QA scrutiny. In the situation where the teleradiology provider is issuing “preliminary” reports (as opposed to “final” reports), all reports are evaluated for accuracy and agreement by the “in house” radiologist, at the time the “final” report is issued. This serves to dramatically increase the sample size of analyzed reports (100% of all preliminary reports), as well as provide a prospective form of an analysis.

Further, with external QA (e.g., outside the teleradiology provider), issues include: a) an extremely large sample size (all preliminary reports “re-read” and subject to peer review); b) prospective analysis (by unaffiliated readers) is required; c) a variable and unnecessary degree of scrutiny is performed (often extremely high level of scrutiny, often unfair and overly scrutinizing); d) follow-up and reporting is left to the discretion of “final” readers, with variable QA standards; e) the “truth” is often established in a subjective fashion; and f. the QA is unidirectional (QA analysis almost entirely focused on report content, with little if any accountability to contributing factors (clinical history, clinical data, image quality, protocols, communication, correlating imaging data).

A somewhat subtle, but albeit real distinction lies in the degree of peer to peer scrutiny being exerted between “internal” and “external” QA programs. While “internal” QA programs are performed among radiologist colleagues working side by side, “external” QA programs are performed by radiologists in different practices, which in some scenarios may be seen as competitive in nature. In such an “external” QA program, there is likely more scrutiny being exerted on those teleradiologists who lie “outside” the practice, than those within. In extreme examples, a radiologist may even look to find fault with even the smallest of differences, in an attempt to exaggerate the number of QA discrepancies. As a result, the QA process becomes highly subjective in nature and occasionally driven by ulterior motives.

Regardless of any insidious motives, the reality in human-derived QA analysis is that inter- and intra-observer variability plays a large role in the inconsistency and lack of standards intrinsic to the QA process. One radiologist may elect to report only those QA discrepancies with profound clinical implications, while another radiologist elects to report all QA discrepancies, independent of clinical impact. A radiologist on one given day may decide to report a divergent finding as a documentable QA discrepancy, when on another day disregard the divergence altogether. The end result is that any QA program dependent upon the subjective analysis of humans is highly variable, and often flawed.

A common (and important) deficiency in either QA program is the inability to establish “truth”. When two radiologists (or clinicians) disagree on a given finding, the final determination of which is correct often lies with group consensus. In few cases is truth established based on clinical or pathologic grounds, for this “downstream” clinical data are commonly temporally disconnected from the imaging exam and report. The ideal (and more accurate) scenario would be to incorporate clinical data (e.g., laboratory tests, pathology report, discharge summary) into the QA reporting analysis, in order to correlate imaging and clinical data in the establishment of “truth”. In the current practice, this is mandated in mammography through the Mammography Quality Standards Act (MQSA), but not in the remaining medical imaging practice. As a result, report “truth” is often established in the absence of clinical data and outcomes analysis; and is often the subject of human bias.

Accordingly, quality-centric data which can be used to determine report accuracy and correlate the data with clinical outcomes, along with improving end-user education and communication, along with a way to automate and customize report content based upon end-user preferences and QA feedback, is desired.

### SUMMARY OF THE INVENTION

The present invention relates to an automated method for Quality Assurance (QA) which creates quality-centric data contained within a medical report, and uses these data elements to determine report accuracy and correlation with clinical outcomes. The present invention also provides a mechanism to enhance end-user education, communication between healthcare providers, categorization of QA deficiencies, and the ability to perform meta-analysis over large end-user populations. In addition to a QA report analysis, the present invention also provides an automated mechanism to customize report content base upon end-user preferences and QA feedback.

In one embodiment consistent with the present invention, a computer-implemented method of an automated medical quality assurance, includes storing quality assurance data and supportive data in at least one database; identifying a quality assurance discrepancy from said quality assurance data; assigning a level of clinical severity, to said quality assurance discrepancy; creating an automated differential diagnosis based on said level of said clinical severity, to determine clinical outcomes; and analyzing said quality assurance data and correlating said analysis of said quality assurance data with said stored supportive data and said clinical outcomes.

In another embodiment consistent with the present invention, the method includes forwarding said analysis of said quality assurance data to involved parties, including a quality assurance committee; and determining whether an adverse outcome is present, based on said quality assurance analysis and correlation.

In yet another embodiment consistent with the present invention, when said adverse outcome is not present, then a meta-analysis of all quality assurance databases is performed.

In yet another embodiment consistent with the present invention, the identifying step includes at least one of data mining of said quality assurance data using artificial intelligence, a natural language processing of reports, and a statistical analysis of clinical databases for a determination of quality assurance outliers.

In yet another embodiment consistent with the present invention, the storing step includes recording at least one of a type of quality assurance discrepancy, a date and time of occurrence of said quality assurance discrepancy, names of involved parties, a source of said quality assurance data, and a technology used.

In yet another embodiment consistent with the present invention, the level of said clinical severity is assigned as one of low, uncertain, moderate, high, and emergent

In yet another embodiment consistent with the present invention, when said adverse outcome is determined, said adverse outcome is determined as one of intermediate or highly significant.

In yet another embodiment consistent with the present invention, said adverse outcome includes additional patient recommendations, including a prolonged hospital stay in an intermediate adverse outcome, or including a transfer to an intensive care unit in a highly significant adverse outcome.

In yet another embodiment consistent with the present invention, when said adverse outcome is determined, said adverse outcome, its findings, said clinical severity values, quality assurance scores, and said supportive data, are automatically communicated to stakeholders.

In yet another embodiment consistent with the present invention, the method includes triggering a review by said quality assurance committee, based upon said level of clinical severity of said quality assurance discrepancy in said adverse outcome.

In yet another embodiment consistent with the present invention, the method includes storing said recommended actions made by said quality assurance committee for intervention, including at least one of remedial education, probation, or adjustment of credentials.

In yet another embodiment consistent with the present invention, the method includes forwarding an alert with said recommended actions from said quality assurance committee, to a medical professional committing said quality assurance discrepancy.

In yet another embodiment consistent with the present invention, the method includes storing said recommended actions from said quality assurance committee; and forwarding said recommended actions to at least said stakeholders and medical professionals.

In yet another embodiment consistent with the present invention, the method includes performing an analysis of said quality assurance data for trending analysis, education, training, credentialing, and performance evaluation of said medical professionals.

In yet another embodiment consistent with the present invention, the method includes providing accountability standards for use by said medical professionals and institutions.

In yet another embodiment consistent with the present invention, the method includes including said quality assurance data in quality assurance Scorecards for at least trending analysis.

In yet another embodiment consistent with the present invention, the method includes preparing a customized quality assurance report which is forwarded to said medical professionals.

In yet another embodiment consistent with the present invention, said quality assurance report includes at least one of: quality assurance standards; an objective analysis in establishment of “truth”; routine bidirectional feedback; multi-directional accountability; integration of multiple data elements; and context and user-specific longitudinal analysis.

In yet another embodiment consistent with the present invention, said quality assurance discrepancies include at least one of complacency; faulty reasoning; lack of knowledge; perceptual error; communication error; technical error; complications; and inattention.

In yet another embodiment consistent with the present invention, said supportive quality assurance data includes at least one of historical imaging reports; clinical test data; laboratory and pathology data; patient history and physical data; consultation notes; discharge summary; quality assurance Scorecard databases; evidence-based medicine (EBM) guidelines; documented adverse outcomes; or automated decision support systems.

In yet another embodiment consistent with the present invention, said identifying step includes: identifying a quality assurance discrepancy using an automated CAD analysis; providing quantitative and qualitative analysis of any findings; and utilizing natural language processing tools to analyze retrospective and prospective imaging reports to identify a presence of a pathologic finding.

In yet another embodiment consistent with the present invention, at least one of a source of a potential quality assurance discrepancy, a finding in question, a clinical significance of said potential quality assurance discrepancy, identifying data of quality assurance report authors, and computer-derived quantitative/qualitative measures, are stored in said quality assurance database.

In yet another embodiment consistent with the present invention, said automated differential diagnosis is based on patient medical history, laboratory data, and ancillary clinical tests.

In yet another embodiment consistent with the present invention, in a low level of clinical severity, no further action is required if said quality assurance discrepancy is an isolated event.

In yet another embodiment consistent with the present invention, in a low level of clinical severity, automated quality assurance alerts are sent to involved parties if said quality assurance discrepancy is a repetitive problem.

In yet another embodiment consistent with the present invention, in an uncertain level of clinical severity, a clinical significance of said quality assurance data is established and a pathway of corresponding level of clinical severity is taken.

In yet another embodiment consistent with the present invention, when said clinical significance remains uncertain, then future analysis is performed on said quality assurance database, and an alert is sent to a quality assurance professional for follow-up.

In yet another embodiment consistent with the present invention, clinical databases are mined for a determination of said level of clinical severity, and once said level of clinical severity is established, said pathway of corresponding level of clinical severity is taken.

In yet another embodiment consistent with the present invention, in a moderate level of clinical severity, automated quality assurance alerts are sent to involved parties for mandatory follow-up and documented in said quality assurance database, and a response from said involved parties is documented and sent to a quality assurance professional for review.

In yet another embodiment consistent with the present invention, wherein when follow-up by said involved parties is sufficient, no further action is taken; and wherein when follow-up by said involved parties is insufficient, further analysis of said quality assurance data is forwarded to a quality assurance professional for review.

In yet another embodiment consistent with the present invention, when said quality assurance professional determines further action is required, a quality assurance committee is notified and recommends additional action which is forwarded to said involved parties and stored in said database.

In yet another embodiment consistent with the present invention, in a high or emergent level of clinical severity, automated quality assurance alerts are sent to all involved parties, and immediate action and a formal response are requested.

In yet another embodiment consistent with the present invention, a quality assurance committee reviews said quality assurance discrepancy and makes recommendations on actions to be taken, said actions which are tracked by a quality assurance professional for compliance.

In yet another embodiment consistent with the present invention, when said actions are non-compliant, said quality assurance committee again reviews said actions for further follow-up, and said clinical outcomes are recorded and correlated with said quality assurance discrepancy and said actions taken.

In yet another embodiment consistent with the present invention, the method further includes pooling multiple quality assurance databases to provide a statistical analysis of quality assurance variations.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a schematic drawing of the major components of a radiological system using an automated method of medical QA, according to one embodiment consistent with the present invention.

FIG. 2 is a detailed flowchart of a determination of low clinical severity of a QA discrepancy, according to one embodiment consistent with the present invention.

FIG. 3 is a detailed flowchart of a determination of uncertain clinical severity of a QA discrepancy, according to one embodiment consistent with the present invention.

FIG. 4 is a detailed flowchart of a determination of moderate clinical severity of a QA discrepancy, according to one embodiment consistent with the present invention.

FIG. 5 is a detailed flowchart of a determination of high and emergent clinical severity of a QA discrepancy, according to one embodiment consistent with the present invention.

FIG. 6 is a flowchart showing the steps in performing a QA analysis, according to one embodiment consistent with the present invention.

FIG. 7 is a flowchart showing a continuation of the steps of FIG. 6, according to one embodiment consistent with the present invention.

### DESCRIPTION OF THE INVENTION

The present invention relates to an automated method of medical QA that creates quality-centric data contained within a medical report, and uses these data elements to determine report accuracy and correlation with clinical outcomes. The present invention also provides a mechanism to enhance end-user education, communication between healthcare providers, categorization of QA deficiencies, and the ability to perform meta-analysis over large end-user populations. In addition to a QA report analysis, the present invention also provides an automated mechanism to customize report content base upon end-user preferences and QA feedback.

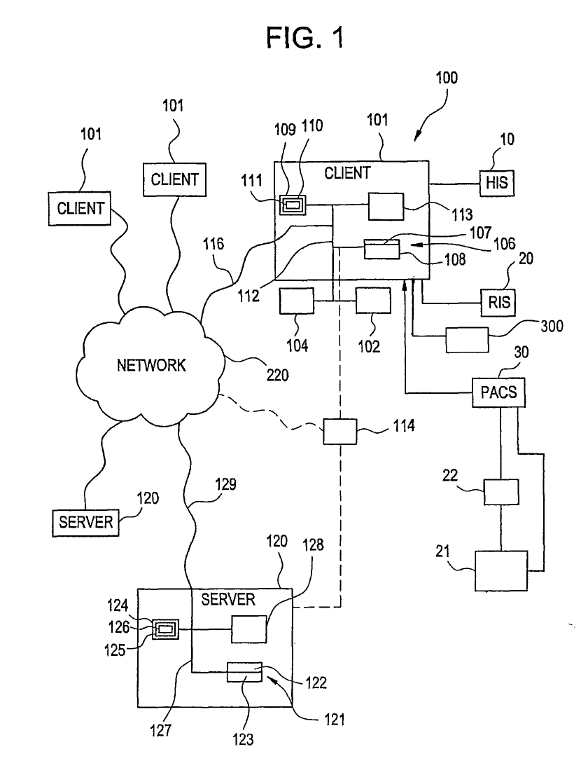

According to one embodiment of the invention, as illustrated in FIG. 1, medical (radiological) applications may be implemented using the system 100. The system 100 is designed to interface with existing information systems such as a Hospital Information System (HIS) 10, a Radiology Information System (RIS) 20, a radiographic device 21, and/or other information systems that may access a computed radiography (CR) cassette or direct radiography (DR) system, a CR/DR plate reader 22, a Picture Archiving and Communication System (PACS) 30, an eye movement detection apparatus 300, and/or other systems. The system 100 may be designed to conform with the relevant standards, such as the Digital Imaging and Communications in Medicine (DICOM) standard, DICOM Structured Reporting (SR) standard, and/or the Radiological Society of North America's Integrating the Healthcare Enterprise (IHE) initiative, among other standards.

According to one embodiment, bi-directional communication between the system 100 of the present invention and the information systems, such as the HIS 10, RIS 20, radiographic device 21, CR/DR plate reader 22, PACS 30, and eye movement detection apparatus 300, etc., may be enabled to allow the system 100 to retrieve and/or provide information from/to these systems. According to one embodiment of the invention, bi-directional communication between the system 100 of the present invention and the information systems allows the system 100 to update information that is stored on the information systems. According to one embodiment of the invention, bi-directional communication between the system 100 of the present invention and the information systems allows the system 100 to generate desired reports and/or other information.

The system 100 of the present invention includes a client computer 101, such as a personal computer (PC), which may or may not be interfaced or integrated with the PACS 30. The client computer 101 may include an imaging display device 102 that is capable of providing high resolution digital images in 2-D or 3-D, for example. According to one embodiment of the invention, the client computer 101 may be a mobile terminal if the image resolution is sufficiently high. Mobile terminals may include mobile computing devices, a mobile data organizer (PDA), or other mobile terminals that are operated by the user accessing the program 110 remotely. According to another embodiment of the invention, the client computers 101 may include several components, including processors, RAM, a USB interface, a telephone interface, microphones, speakers, a computer mouse, a wide area network interface, local area network interfaces, hard disk drives, wireless communication interfaces, DVD/CD readers/burners, a keyboard, and/or other components. According to yet another embodiment of the invention, client computers 101 may include, or be modified to include, software that may operate to provide data gathering and data exchange functionality.

According to one embodiment of the invention, an input device 104 or other selection device, may be provided to select hot clickable icons, selection buttons, and/or other selectors that may be displayed in a user interface using a menu, a dialog box, a roll-down window, or other user interface. In addition or substitution thereof, the input device may also be an eye movement detection apparatus 300, which detects eye movement and translates those movements into commands.

The user interface may be displayed on the client computer 101. According to one embodiment of the invention, users may input commands to a user interface through a programmable stylus, keyboard, mouse, speech processing device, laser pointer, touch screen, or other input device 104, as well as an eye movement detection apparatus 300.

According to one embodiment of the invention, the client computer system 101 may include an input or other selection device 104, 300 which may be implemented by a dedicated piece of hardware or its functions may be executed by code instructions that are executed on the client processor 106. For example, the input or other selection device 104, 300 may be implemented using the imaging display device 102 to display the selection window with an input device 104, 300 for entering a selection.

According to another embodiment of the invention, symbols and/or icons may be entered and/or selected using an input device 104 such as a multi-functional programmable stylus 104. The multi-functional programmable stylus may be used to draw symbols onto the image and may be used to accomplish other tasks that are intrinsic to the image display, navigation, interpretation, and reporting processes, as described in U.S. patent application Ser. No. 11/512,199 filed on Aug. 30, 2006, the entire contents of which are hereby incorporated by reference. The multi-functional programmable stylus may provide superior functionality compared to traditional computer keyboard or mouse input devices. According to one embodiment of the invention, the multi-functional programmable stylus also may provide superior functionality within the PACS 30 and Electronic Medical Report (EMR).

In one embodiment consistent with the present invention, the eye movement detection apparatus 300 that is used as an input device 104, computes line of gaze and dwell time based on pupil and corneal reflection parameters. However, other types of eye tracking devices may be used, as long they are able to compute line of gaze and dwell time with sufficient accuracy.

According to one embodiment of the invention, the client computer 101 may include a processor 106 that provides client data processing. According to one embodiment of the invention, the processor 106 may include a central processing unit (CPU) 107, a parallel processor, an input/output (I/O) interface 108, a memory 109 with a program 110 having a data structure 111, and/or other components. According to one embodiment of the invention, the components all may be connected by a bus 112. Further, the client computer 101 may include the input device 104, 300, the image display device 102, and one or more secondary storage devices 113. According to one embodiment of the invention, the bus 112 may be internal to the client computer 101 and may include an adapter that enables interfacing with a keyboard or other input device 104. Alternatively, the bus 112 may be located external to the client computer 101.

According to one embodiment of the invention, the client computer 101 may include an image display device 102 which may be a high resolution touch screen computer monitor. According to one embodiment of the invention, the image display device 102 may clearly, easily and accurately display images, such as x-rays, and/or other images. Alternatively, the image display device 102 may be implemented using other touch sensitive devices including tablet personal computers, pocket personal computers, plasma screens, among other touch sensitive devices. The touch sensitive devices may include a pressure sensitive screen that is responsive to input from the input device 104, such as a stylus, that may be used to write/draw directly onto the image display device 102.

According to another embodiment of the invention, high resolution goggles may be used as a graphical display to provide end users with the ability to review images. According to another embodiment of the invention, the high resolution goggles may provide graphical display without imposing physical constraints of an external computer.

According to another embodiment, the invention may be implemented by an application that resides on the client computer 101, wherein the client application may be written to run on existing computer operating systems. Users may interact with the application through a graphical user interface. The client application may be ported to other personal computer (PC) software, personal digital assistants (PDAs), cell phones, and/or any other digital device that includes a graphical user interface and appropriate storage capability.

According to one embodiment of the invention, the processor 106 may be internal or external to the client computer 101. According to one embodiment of the invention, the processor 106 may execute a program 110 that is configured to perform predetermined operations. According to one embodiment of the invention, the processor 106 may access the memory 109 in which may be stored at least one sequence of code instructions that may include the program 110 and the data structure 111 for performing predetermined operations. The memory 109 and the program 110 may be located within the client computer 101 or external thereto.

While the system of the present invention may be described as performing certain functions, one of ordinary skill in the art will readily understand that the program 110 may perform the function rather than the entity of the system itself.

According to one embodiment of the invention, the program 110 that runs the system 100 may include separate programs 110 having code that performs desired operations. According to one embodiment of the invention, the program 110 that runs the system 100 may include a plurality of modules that perform sub-operations of an operation, or may be part of a single module of a larger program 110 that provides the operation.

According to one embodiment of the invention, the processor 106 may be adapted to access and/or execute a plurality of programs 110 that correspond to a plurality of operations. Operations rendered by the program 110 may include, for example, supporting the user interface, providing communication capabilities, performing data mining functions, performing e-mail operations, and/or performing other operations.

According to one embodiment of the invention, the data structure 111 may include a plurality of entries. According to one embodiment of the invention, each entry may include at least a first storage area, or header, that stores the databases or libraries of the image files, for example.

According to one embodiment of the invention, the storage device 113 may store at least one data file, such as image files, text files, data files, audio files, video files, among other file types. According to one embodiment of the invention, the data storage device 113 may include a database, such as a centralized database and/or a distributed database that are connected via a network. According to one embodiment of the invention, the databases may be computer searchable databases. According to one embodiment of the invention, the databases may be relational databases. The data storage device 113 may be coupled to the server 120 and/or the client computer 101, either directly or indirectly through a communication network, such as a LAN, WAN, and/or other networks. The data storage device 113 may be an internal storage device. According to one embodiment of the invention, the system 100 may include an external storage device 114. According to one embodiment of the invention, data may be received via a network and directly processed.

According to one embodiment of the invention, the client computer 101 may be coupled to other client computers 101 or servers 120. According to one embodiment of the invention, the client computer 101 may access administration systems, billing systems and/or other systems, via a communication link 116. According to one embodiment of the invention, the communication link 116 may include a wired and/or wireless communication link, a switched circuit communication link, or may include a network of data processing devices such as a LAN, WAN, the Internet, or combinations thereof. According to one embodiment of the invention, the communication link 116 may couple e-mail systems, fax systems, telephone systems, wireless communications systems such as pagers and cell phones, wireless PDA's and other communication systems.

According to one embodiment of the invention, the communication link 116 may be an adapter unit that is capable of executing various communication protocols in order to establish and maintain communication with the server 120, for example. According to one embodiment of the invention, the communication link 116 may be implemented using a specialized piece of hardware or may be implemented using a general CPU that executes instructions from program 110. According to one embodiment of the invention, the communication link 116 may be at least partially included in the processor 106 that executes instructions from program 110.

According to one embodiment of the invention, if the server 120 is provided in a centralized environment, the server 120 may include a processor 121 having a CPU 122 or parallel processor, which may be a server data processing device and an I/O interface 123. Alternatively, a distributed CPU 122 may be provided that includes a plurality of individual processors 121, which may be located on one or more machines. According to one embodiment of the invention, the processor 121 may be a general data processing unit and may include a data processing unit with large resources (i.e., high processing capabilities and a large memory for storing large amounts of data).

According to one embodiment of the invention, the server 120 also may include a memory 124 having a program 125 that includes a data structure 126, wherein the memory 124 and the associated components all may be connected through bus 127. If the server 120 is implemented by a distributed system, the bus 127 or similar connection line may be implemented using external connections. The server processor 121 may have access to a storage device 128 for storing preferably large numbers of programs 110 for providing various operations to the users.

According to one embodiment of the invention, the data structure 126 may include a plurality of entries, wherein the entries include at least a first storage area that stores image files. Alternatively, the data structure 126 may include entries that are associated with other stored information as one of ordinary skill in the art would appreciate.

According to one embodiment of the invention, the server 120 may include a single unit or may include a distributed system having a plurality of servers 120 or data processing units. The server(s) 120 may be shared by multiple users in direct or indirect connection to each other. The server(s) 120 may be coupled to a communication link 129 that is preferably adapted to communicate with a plurality of client computers 101.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer 101, the server 120, or both.

According to one embodiment of the invention, in a client-server environment, at least one client and at least one server are each coupled to a network 220, such as a Local Area Network (LAN), Wide Area Network (WAN), and/or the Internet, over a communication link 116, 129. Further, even though the systems corresponding to the HIS 10, the RIS 20, the radiographic device 21, the CR/DR reader 22, the PACS 30 (if separate), and the eye movement detection apparatus 30, are shown as directly coupled to the client computer 101, it is known that these systems may be indirectly coupled to the client over a LAN, WAN, the Internet, and/or other network via communication links. Further, even though the eye movement detection apparatus 300 is shown as being accessed via a LAN, WAN, or the Internet or other network via wireless communication links, it is known that the eye movement detection apparatus 300 could be directly coupled using wires, to the PACS 30, RIS 20, radiographic device 21, or HIS 10, etc.

According to one embodiment of the invention, users may access the various information sources through secure and/or non-secure interne connectivity. Thus, operations consistent with the present invention may be carried out at the client computer 101, at the server 120, or both. The server 120, if used, may be accessible by the client computer 101 over the Internet, for example, using a browser application or other interface.

According to one embodiment of the invention, the client computer 101 may enable communications via a wireless service connection. The server 120 may include communications with network/security features, via a wireless server, which connects to, for example, voice recognition or eye movement detection. According to one embodiment, user interfaces may be provided that support several interfaces including display screens, voice recognition systems, speakers, microphones, input buttons, eye movement detection apparatuses, and/or other interfaces. According to one embodiment of the invention, select functions may be implemented through the client computer 101 by positioning the input device 104 over selected icons. According to another embodiment of the invention, select functions may be implemented through the client computer 101 using a voice recognition system or eye movement detection apparatus 300 to enable hands-free operation. One of ordinary skill in the art will recognize that other user interfaces may be provided.

According to another embodiment of the invention, the client computer 101 may be a basic system and the server 120 may include all of the components that are necessary to support the software platform. Further, the present client-server system may be arranged such that the client computer 101 may operate independently of the server 120, but the server 120 may be optionally connected. In the former situation, additional modules may be connected to the client computer 101. In another embodiment consistent with the present invention, the client computer 101 and server 120 may be disposed in one system, rather being separated into two systems.

Although the above physical architecture has been described as client-side or server-side components, one of ordinary skill in the art will appreciate that the components of the physical architecture may be located in either client or server, or in a distributed environment.

Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

The underlying technology allows for replication to various other sites. Each new site may maintain communication with its neighbors so that in the event of a catastrophic failure, one or more servers 120 may continue to keep the applications running, and allow the system to load-balance the application geographically as required.

Further, although aspects of one implementation of the invention are described as being stored in memory, one of ordinary skill in the art will appreciate that all or part of the invention may be stored on or read from other computer-readable media, such as secondary storage devices, like hard disks, floppy disks, CD-ROM, a carrier wave received from a network such as the Internet, or other forms of ROM or RAM either currently known or later developed. Further, although specific components of the system have been described, one skilled in the art will appreciate that the system suitable for use with the methods and systems of the present invention may contain additional or different components.

The present invention provides a method for a QA program driven by reproducible and objective standards, which can be largely automated, so that human variability is removed from the QA analysis. By doing so, the computer program 110 derived analysis is consistent, reproducible, and iterative in nature. The same rule set is applied to all reports and authors by the program 110, irrespective of their affiliation or practice type. At the same time, the data derived from this automated QA analysis by the program 110 is structured in nature, thereby generating a referenceable QA database 113, 114 for clinical analysis, education & training, and technology development.

One optimal QA report program and its attributes would include: 1) the establishment of QA standards (i.e., definitions, categorization of discrepancies, communication pathways); 2) objective analysis in establishment of “truth”; 3) routine bidirectional feedback; 4) multi-directional accountability (i.e., physician order, technologist, etc.); 4) integration of multiple data elements (i.e., imaging, historical, lab/path, physical exam); and 5) context and user-specific longitudinal analysis.

With respect to QA standards, QA metrics would be defined in standardized terms, with a classification schema of QA discrepancies based upon a reproducible grading scale tied to clinical outcome measures. A standardized communication protocol is integrated into the QA program 110 to ensure that all discrepancies are recorded and communicated in a timely fashion, with receipt confirmation documented by the program 110.

Objective analysis by the program 110 would be utilized, so that “truth” would be established based on clinical grounds through the integration of imaging, clinical, and outcomes data, for example. As additional clinical data elements are obtained (in the healthcare continuum of the patient), these would be integrated with the original imaging report findings by the program 110, and updated to reflect the new knowledge gained. As a result, the determination and classification of report discrepancies would be a dynamic (as opposed to static) process, with revised data continually provided to the authoring physician for education.

An equally important (yet currently overlooked) component of report QA analysis is the critical review of supporting data. This can include all the requisite data required to make a correct diagnosis. A radiologist tasked with interpretation of an abdominal CT exam, for example, is far more likely to render an accurate diagnosis given a detailed clinical history (e.g., 7 days status post appenedectomy with post-operative pain, fever, and leukocytosis), than a radiologist given little or no pertinent history (abdominal pain). At the same time, radiologist report accuracy will be partly dependent upon the conspicuity of pathology, which in turn is highly dependent upon image quality. The net result is report accuracy is dependent upon several factors, which go beyond the ability to identify disease alone. The ability to discriminate normal from abnormal, provide an appropriate clinical diagnosis, demonstrate confidence in diagnosis, and make the appropriate clinical recommendations, for example, are all an integral part of the radiology report, which should enter into the comprehensive QA analysis.

The classification of medical errors includes the following, for example: complacency; faulty reasoning; lack of knowledge; perceptual; communication; technical; complications; and inattention.

Complacency, faulty reasoning, and lack of knowledge all represent cognitive errors, in which the finding is visualized but incorrectly interpreted. Faulty reasoning and lack of knowledge represent misclassification of true positives, whereas complacency represents over-reading and misinterpretation of a false positive (e.g., anatomic variant misdiagnosed as a pathologic finding). Perceptual errors are frequent within radiology, and are the result of inadequate visual search, resulting in a “missed” finding, which constitutes a false negative. Communication errors most commonly involve a correct interpretation which has not reached the clinician. Technical errors represent a false negative error, which was not identified due to technical deficiencies (e.g., image quality). The category of errors labeled “complications” represents untoward events (i.e., adverse outcomes), which are commonly seen in the setting of invasive procedures. The last category of error “inattention” refers to an error of omission, caused by a failure to utilize all available data to render appropriate diagnosis.

The present invention would include identifying QA discrepancies through either manual or automated input by the program 110. In the manual mode of operation, a third party (e.g., clinician) could identify a perceived error within the report and record this into the QA database 113, 114 for further analysis. The QA discrepancy would be classified by the program 110 according to the specific type of perceived error (as noted above), clinical significance, and supporting data.

With respect to the categorization of medical QA discrepancies and their clinical significance, the categories include: Category 1: Low clinical significance, follow-up not required; Category 2: Uncertain clinical significance, follow-up discretionary; Category 3: Moderate clinical significance, follow-up required; Category 4: High (non-emergent) clinical significance, notification and clinical action required; and Category 5: Extremely high (emergent) clinical significance, emergent notification and clinical action required.

Supportive QA data includes: 1) Historical imaging reports; 2) Clinical test data; 3) Laboratory and pathology data; 4) History and physical; 5) Consultation notes; 6) Discharge summary; 7) QA Scorecard databases 113, 114; 8) Evidence-based medicine (EBM) guidelines; 9) Documented adverse outcomes; and 10) Automated decision support systems.

As an example, a patient undergoes a chest radiograph in the evaluation of chronic cough. The radiologist interpreting the exam renders a diagnosis of “no active disease”. The same patient subsequently undergoes a chest CT exam and is found to have a 10 mm nodule in the right lung, suspicious for cancer. A number of possible QA discrepancy reporting events could occur in association with this case, for example, as outlined below.

In the example, the referring clinician, reading the chest CT report, believes the interpretation of the chest radiographic exam was erroneous and “missed” the right upper lobe nodule, which was later identified on chest CT. He elects to manually report a QA discrepancy on the chest radiographic report by entering the following information into the QA database: 1) Perceived error: lung nodule, right upper lobe; 2) Clinical significance: high, non-emergent; 3) Supporting data: chest CT report dated Oct. 7, 2008.

In another example, the radiologist interpreting the chest CT exam reviews the chest radiographic exam at the time of CT interpretation and retrospectively identifies the nodule in question. He elects to report a QA discrepancy by entering the following data into the QA database 113, 114: 1) Perceived error: lung nodule, right upper lobe; 2) Clinical significance: moderate; and 3) Supporting data: chest CT Oct. 7, 2008 (sequence 2, image 23).

In another example, the thoracic surgeon who is consulted for a possible thoracoscopy, reviews the patient medical record, imaging folder, and performs a physical examination. During the course of his consultation, the surgeon is able to locate an additional chest radiographic examination performed one year earlier, along with the current chest radiographic and CT exams. He believes the nodule in question was present on the two (2) serial chest radiographic exams and has demonstrated interval growth, from 5 mm to 10 mm. He records a QA discrepancy with the following data: 1) Perceived error: lung nodule, right upper lobe; 2) Clinical significance: high, non-emergent; and 3) Supporting data: a) chest radiograph Sep. 25, 2007 (PA view); b) chest radiograph Sep. 5, 2008 (PA view); and c) chest CT Oct. 7, 2008 (sequence 2, image 23 and sequence 4, image 12).

In one mode of operation, the various QA discrepancy reports would be recorded into the QA database 113, 114 by the program 110, and triaged by the program 110 in accordance with the reported level of clinical significance, for example. Those QA discrepancies recorded as having clinical significance scores of 4 and 5 (high clinical significance) would be prioritized by the program 110, and made subject to immediate peer review within 48 hours of submission. Those with a reported clinical significance score of 3 (moderate clinical significance), for example, would be intermediate in priority and require peer review within 5 working days.

The manual peer review process would consist of a review by a multi-disciplinary QA committee (consisting of radiologist, clinician, medical physicist, technologist, administrator, and nurse, for example) which is tasked with reviewing all pertinent clinical, imaging, and technical data to determine by group consensus the validity and severity of the reported QA discrepancy. In this particular case, the patient's clinical (EMR), imaging (PACS), and technical (RIS) data would be reviewed, including the data made available to the radiologist at the time of image interpretation.

In this particular example, the radiologist interpreting the Sep. 5, 2008 chest radiographic exam was not provided access to either the images or report from the prior chest radiographic study dated Sep. 25, 2007, and was provided with a paucity of patient historical data. Retrospective analysis of the Sep. 5, 2008 exam revealed the 10 mm right upper lobe nodule was difficult (but not impossible to) to visualize, and therefore classified the QA discrepancy as “invalid”, resulting in no recorded QA discrepancy associated with the report and interpreting radiologist.

If, on the other hand, the prior chest radiograph and corresponding report from Sep. 25, 2007 was indeed available, but not accessed at the time of the Sep. 5, 2008 interpretation, a different QA outcome would have resulted. In this case, the prior report described a “subtle 5 mm nodular density of uncertain clinical significance within the right upper lung field” and went on to “recommend chest CT for further evaluation”. The QA committee would then conclude that had the radiologist interpreting the Sep. 5, 2008 study consulted the previous report and images, he should have been able to detect the 10 mm right upper lobe nodule, and as a result this did indeed represent a “valid” QA discrepancy. Based on the available data, the discrepancy was categorized and stored by the program 110 as combined “perceptual “and “inattention” errors. The “perceptual” error was the result of failing to visualize a pathologic finding which could be seen on the serial radiographic studies, and the “inattention” error, due to the failure of the radiologist to utilize available data (prior chest radiographic study and report) to render appropriate diagnosis.

During the course of the peer review, the committee also cited two additional QA concerns. The first was related to the image quality of the Sep. 5, 2008 chest radiographic study, which was found to be of poor quality (related to image exposure), thereby contributing to the missed diagnosis. As a result, the technologist performing the exam was cited by the QA committee, resulting in an alert being sent by the program 110 to the technologist (with the corresponding images and recommendations), along with a record sent to the individual technologist's and departmental QA Scorecards per U.S. patent application Ser. Nos. 11/699,348, 11/699,349, 11/699,350, 11/699,344, and 11/699,351.

At the same time in the example, the QA committee noted that the Sep. 25, 2007 chest radiograph report recommendations were not followed, which resulted in delayed diagnosis (and a potential adverse clinical outcome) of the lung nodule in question. As a result, the clinician ordering that study was sent a notification of the event by the program 110, with a QA recommendation to audit that physician's imaging and laboratory test results for 6 months.

This chain of events would be representative of how the present invention would function, with the QA data input and analysis performed by the user, and all outcome data recorded in a QA database 113, 114 for future trending analysis, education & training, credentialing, and performance evaluation by the program 110.

In a fully automated embodiment of the QA discrepancy reporting and analysis system, the invention would utilize a number of computer-based technologies including (but not limited to) computer-aided detection (CAD) software for identification of pathologic findings within the imaging dataset (e.g., lung nodule detection), natural language processing (NLP) for automated data mining of clinical and imaging report data, artificial intelligence techniques (e.g., neural networks) for interpretive analysis and correlation of disparate medical datasets, computerized communication pathways (e.g., Gesture-Based Reporting-based critical results communication protocols) for recording and notification of clinically significant findings and QA discrepancies.

Using the previous example of a “missed” lung nodule on a chest radiographic report, the following sequence of events would be utilized to trigger, record, analyze, and communicate QA data using the program 110.

First, the identification of a potential QA discrepancy could take place in several ways:

a) the automated CAD analysis of the program 110 would identify a potential lung nodule within the right upper lobe on the chest radiographic image and provide quantitative and qualitative analysis of the finding (e.g., size, morphology, sensitivity/specificity).

b) NLP tools analyzing retrospective and prospective imaging reports could utilize the program 110 to identify the presence of a pathologic finding (e.g., right upper lobe nodule) on the historical chest radiographic report and/or current chest CT report. The absence of a similar finding on the current chest radiographic report would trigger an automated alert by the program 110, as to a potential QA discrepancy.

c) The consultative report of the surgeon using gesture-based reporting (GBR) (see U.S. Pat. No. 7,421,647, the contents of which are herein incorporated by reference in its entirety), for example, would have the program 110 recognize an additional finding (right upper lobe nodule) not contained within the final radiologist report (by the presence of a new symbol for nodule) and the program 110 would initiate a “new” or “additional” finding. The presence of an edited symbol would trigger the QA protocol to be initiated by the program 110.

Once the QA protocol has been initiated, a sequence of events would activate a QA query by the program 110, for example, with the following data elements recorded in the QA database 113, 114 by the program 110: a) Source of potential discrepancy; b) Finding in question; c) Clinical significance of the potential discrepancy; d) Identifying data of the report authors; and e) Computer-derived quantitative/qualitative measures.

Then, clinical data from the patient EMR would be cross-referenced by the program 110 with the new/altered imaging data to create an automated differential diagnosis, based on the patient medical history, laboratory data, and ancillary clinical tests.

Thereafter, the patient imaging and clinical data folders would be flagged by the program 110 so that all subsequent data collected would be recorded, analyzed, and cross-referenced by the program 110 with the finding in question (e.g., pathology results from biopsy).

The program 110 would then calculate an automated outcomes analysis score based upon these various data elements to determine the presence/absence of the “missed” finding and clinical impact.

Thus, the clinical significance of the data would be established by the program 110 (using defined rule sets and artificial intelligence (AI)), and a pathway of corresponding clinical severity will be followed by the program 110. For example, the program 110 will record the data in the QA databases 113, 114 in step 400, and characterize the clinical severity as low in step 401 based upon its defined rule sets and AI. If the program 110 determines the QA discrepancy to be an isolated event in step 402, no further action would be recommended or required by the program in step 403. If the problem is a repetitive one, then additional action would be taken by the program 110, where automated QA alerts would be sent in step 404 to the involved parties and QA Administrator by the program 110, and the QA administrator would recommend further action to be taken in step 405 (delivered by the program 110 to the parties, and stored in the database 113, 114 for future action, etc.) if the problems continue.

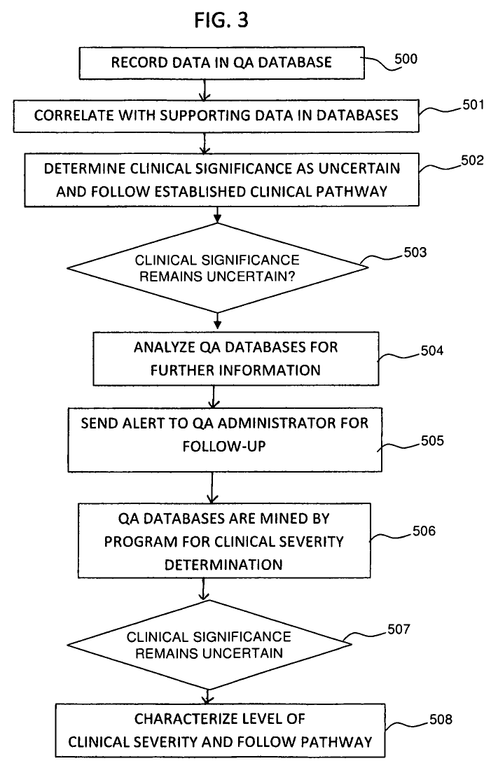

In an uncertain clinical severity situation (see FIG. 3), the program 110 would record the data in the QA databases 113, 114 in step 500. The program 110 would then correlate the data with the supporting data recorded in the databases 113, 114 in step 501. The clinical significance of the data would be established by the program 110 (using defined rule sets and artificial intelligence), and a pathway of corresponding clinical severity will be followed by the program 110 in step 502. If the clinical significance remains uncertain in step 503, then the program 110 would perform further and future analysis on the QA database 113, 114 in step 504. An alert would be sent by the program 110 to the QA administrator for follow-up (using clinical outcomes data) in step 505. However, a computer agent of the program 110 would continue to prospectively mine clinical databases (e.g., EMR) in step 506, for determination of clinical severity. Once clinical severity established in step 507, then the corresponding pathway would be triggered by the program 110 in step 508.

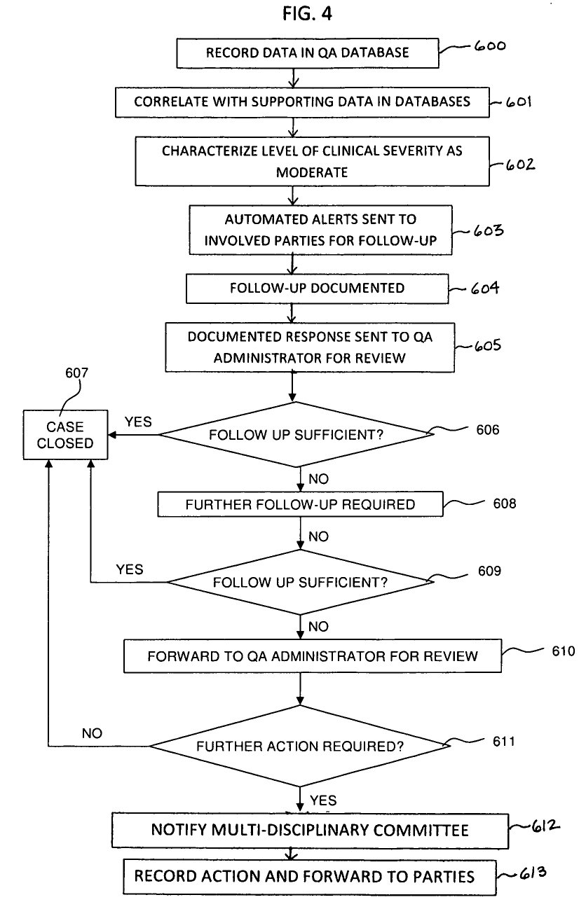

In a moderate clinical severity situation (see FIG. 4), the program 110 would record data in the QA databases 113, 114 in step 600, and the program 110 would correlate the data with the supporting data in step 601. The program 110 would then characterize the level of clinical severity as moderate in step 602. Automated QA alerts would be sent by the program 110 to involved parties for mandatory follow-up in step 603. The follow-up would be documented by the program 110 in the QA database 113, 114 (e.g., imaging study, lab or clinical test, medical management) in step 604, and the documented response would also be sent to the QA administrator for review, by the program 110, in step 605. The program 110 would determine whether follow-up was sufficient in step 606. If follow-up was deemed sufficient based upon the responses, the QA case would be closed in step 607. If the follow-up was deemed insufficient by the program 110, then further-follow up is mandated in step 608. If further follow-up is satisfactory as in step 609, then the QA case is closed as in step 607. If the further follow-up is not satisfactory, then the program 110 would forward the case to the QA administrator for review in step 610. If the QA administrator requires further action in step 611, the program 110 will notify the QA multi-disciplinary committee in step 612. The QA committee would recommend additional action be required (e.g., none, remedial education, mentoring, QA probation), which the program 110 will record and forward to the parties in step 613.

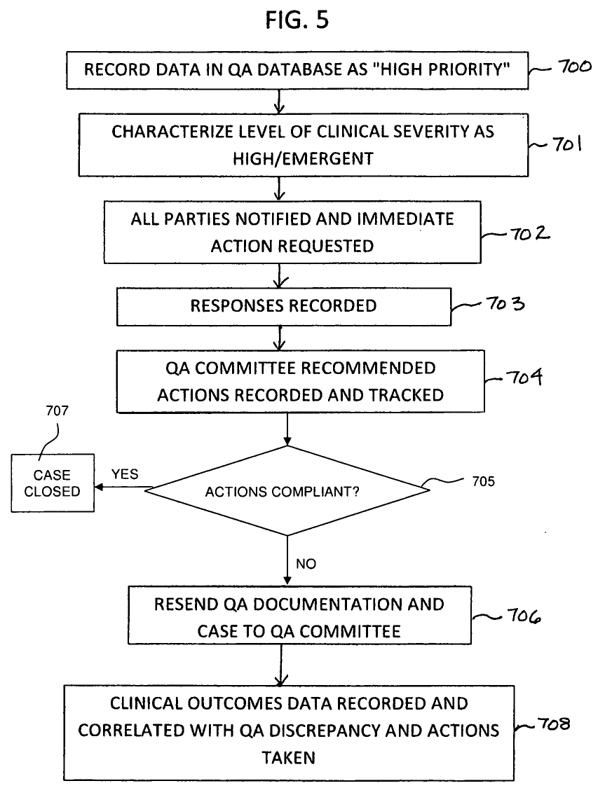

In a high and emergent clinical significance situation (see FIG. 5), the data is recorded in the QA database 113, 114 by the program 110 in step 700, and the program 110 determines the clinical severity as “high priority” in step 701. Thereafter, all the involved parties are notified by the program 110 (with documentation of receipt) in step 702, and immediate action is requested. Formal QA response is required by all the involved parties, and recorded by the program 110 upon receipt in step 703. The QA multi-disciplinary committee will review the QA discrepancy and the actions recommended to be taken in response, are recorded in the QA database 113, 114 in step 704, and tracked by the QA administrator for compliance. If the program 110 monitoring shows the actions taken in response to the recommendations are non-compliant in step 705, documentation in the QA database 113, 114 and the case are resent to the QA committee by the program 110 (with possibility of the user's credentials being revoked), in step 706. If satisfactory, then the case is closed in step 707. Thus, clinical outcomes data is recorded and correlated with the QA discrepancy and the actions taken in step 708, by the program 110.

Noted, the workflow differences between high and emergent QA discrepancies include primarily the level of importance and the mandated response times. High clinical severity responses are required within 6-8 hours of documentation, whereas emergent clinical severity responses are required 1-2 hours of documentation, for example.

Thus, all outcomes analysis scores reaching a pre-defined threshold would create an automated notification pathway for the program lip to alert the various stakeholders involved in the clinical management of the patient, along with all report authors.

Trending analysis of the QA database 113, 114 by the program 110 would identify statistical trends and provide feedback for continuing education, additional training requirements, and credentialing.

These QA data would also become incorporated into the various QA Scorecards as in U.S. patent application Ser. Nos. 11/699,348, 11/699,349, 11/699,350, 11/699,344, and 11/699,351, by the program 110, and serve as an objective measure of quality performance.

While these illustrations of the invention focus on the radiologist's role in QA discrepancies, all individual stakeholders, steps, and technologies involved in medical delivery would be prospectively analyzed using the present invention. In the example of a medical imaging study, the individual steps would include exam ordering, scheduling, protocol selection, image acquisition, historical/clinical data retrieval, image quality assurance (QA), technology quality control (QC), image processing, interpretation, report creation, communication/consultation, clinical/imaging follow-up, and treatment. The individual stakeholders would include the ordering clinician, patient, technologist, clerical staff, radiologist, QA specialist, medical physicist, and administrator. The technologies involved would include the computerized order entry system (CPOE), radiology/hospital information systems (RIS/HIS), electronic medical record (EMR), imaging modality, picture archival and communication system (PACS), QA workstation, and QC phantoms/software.

As defined in U.S. patent application Ser. Nos. 11/699,348, 11/699,349, 11/699,350, 11/699,344, and 11/699,351, objective quality metrics would be defined for each variable in the collective process and serve as a point of overall quality analysis by the program 110. The same type of quality analysis can extend to all other forms of healthcare delivery; including (but not limited to) pharmaceutical administration, cancer treatment, surgery, preventive medicine, and radiation safety.

In any event where the standard of practice is believed to have been violated, a QA event would be triggered at the point of contact by the program 110. In the manual mode of operation, the triggering of the perceived QA discrepancy would be input by an individual, while in the automated mode of operation, the trigger is initiated electronically by the program 110 by a statistical outlier, recorded data element outside the defined parameters of practice standards, or a documented discrepancy in associated data. An example of a statistical outlier could include a radiologist whose recommended biopsy rates on mammography are greater than two (2) standard deviations of his/her reference peer group. An example of recorded data outside the defined parameters of practice standards would be the recommendation of a lung biopsy for a 6 mm lung nodule (where professional guidelines call for conservative management in the form of a 6 month follow-up CT scan). An example of an associated data discrepancy is the cardiac CT angiography reporting normal coronary arteries, while the cardiac nuclear medicine study reported ischemia in the right coronary artery.

In all examples, once a potential QA discrepancy is identified by the program 110, a QA chain of events is automatically triggered by the program 110. In the course of the QA analysis, all relevant data points are collected for analysis as illustrated in the following Table, for example.

TABLE
Comprehensive Data for QA Analysis

| Individual Step | Stakeholder/s | Technology | QA Data for Analysis |
|---|---|---|---|
| Exam Ordering | Clinician | CPOE/RIS | Exam appropriateness |
| | | | Clinical/historical data |
| Historical Data | Technologist | PACS/EMR | Prior imaging data and reports |
| Retrieval | | | |
| Equipment Quality | Medical Physicist | QC Phantoms and | Equipment calibration |
| Control | | Software | Radiation safety |
| Image Acquisition | Technologist | Modality | Exposure parameters |
| | | | Protocol selection |
| Image Processing | Technologist | Modality/ MPR | Data reconstructions |
| | | Workstation | Contrast resolution |
| QA Review | QA Specialist | QA Workstation | Contrast and spatial resolution |
| | | | Artifacts |
| Interpretation | Radiologist | PACS | Diagnostic accuracy |
| | | | (Positive and Negative |
| | | | Predictive Values) |
| Reporting | Radiologist | Reporting | Content and clarity |
| | | System/PACS | Compliance with professional |
| | | | standards |
| Communication | Radiologist/Clinician | PACS/EMR | Critical results |
| | | | communication |
| Follow-up | Administrator | RIS/HIS | Compliance with report |
| | | | follow-up recommendations |
| Treatment | Clinician | EMR | Timeliness and clinical |
| | | | outcomes analysis |

The above Table allows for a comprehensive assessment by the program 110 as to the various confounding variables which may or may not have been contributing factors to the reported QA discrepancy. As these variables are individually and collectively analyzed, the QA data are recorded by the program 110 into the QA databases 113, 114 of the individual stakeholders and technologies for the purposes of trending analysis. In the event that a specific variable was identified as a QA outlier, an automated QA alert would be sent by the program 110 to the respective party, along with supervisory staff being tasked by the program 110 with ensuring QA compliance. In certain circumstances (e.g., high clinical significance or repetitive QA discrepancies), the individual party may be required to undergo additional education and training and/or more intensive QA monitoring, as triggered by the program 110. In the event that the equipment (technology) is deemed to be a causative or contributing factor to the QA discrepancies, mandatory testing would be required by the program 110 prior to continued use (i.e., the program 110 may also shut down the equipment involved).

The automated and peer review QA analyses generated by the program 110 would capture multiple data elements, which would be sent by the program 110 to the respective QA parties for documentation, education and training, and feedback. A representative QA analysis by the program 110 would contain the following data: 1) Reported QA Discrepancy (i.e., missed diagnosis (right breast micro-calcification); 2) QA Data Source (i.e., a) Automated CAD Software Program; and b) Substantiated by Radiologist Peer Review); 3) Involved Parties (i.e., Dr. Blue, Dr. Gold); 4) Date and Time of Occurrence (i.e., Oct. 20, 2009 at 10:05 am); 5) Technology Utilized (i.e., Bilateral screening mammogram); 6) Type of QA Discrepancy (i.e., Perceptual error); 7) Severity of QA Discrepancy (i.e., Category 4: High (non-emergent) clinical significance, biopsy required); 8) Clinical Outcome (i.e., Pathology results positive for ductal carcinoma in situ; Patient referred for surgical consultation); 9) Contributing Factors (i.e., a) Incomplete review of historical imaging studies (comparison mammogram Aug. 27, 2007; b) Limited motion artifact on mammographic images; c) Non-utilization of CAD program); and 10) Recommended Actions (i.e., a) Mandatory review of comparison imaging data and inclusion of CAD; b) Radiologist CME program for mammography; c) Adoption of automated QA for mammography; d) Technologist mentoring on motion artifact detection by supervisory technologist).

Another important component of the invention is the ability of the program 110 to create accountability standards within the QA reporting by peers, professional colleagues, and lay persons. This accountability goes in both directions; from the individual who omits reporting QA discrepancies of clinical significance, to reported QA discrepancies which are exaggerated or capricious. Since the entire QA reporting process and analysis is tracked by the program 110 in a series of QA databases 113, 114, this information can be evaluated on a longitudinal basis and individuals who are repeated QA outliers can be identified and held accountable. A few relevant examples of inappropriate QA reporting are as follows:

1. The patient who reports a QA discrepancy without clinical merit.

2. A physician who ignores a clinically significant QA discrepancy on a professional colleague.

3. The administrator who ignores repeated QA discrepancies by staff members within his/her department.

4. The technology vendor who provides faulty information to the QA review committee, in an attempt to cover up QA violations.

5. The healthcare professional who attempts to illegally access QA data under a false identity.

The ability to record, track, and analyze all actions related to the QA database 113, 114 by the program 110 is an intrinsic function of the invention. For the purposes of authentication and identification of the reporting party (as well as all others involved in QA data recording, storage, transmission, review, and analysis), Biometrics, such as that disclosed in U.S. patent Ser. No. 11/790,843, the contents of which are herein incorporated by reference in its entirety) is utilized. This ensures that the QA data access is secure and available to only those individuals with the appropriate credentials and authorization. This is important when analyzing the step-wise process which occurs in a multi-step, multi-party, and multi-institutional process such as pharmaceutical administration, for example. Since multiple parties (clinician, patient, nurse, pharmacist, drug manufacturer) are involved in the multi-step process of drug delivery (manufacture, clinical testing, procurement, dispersal, administration, monitoring, and management), which occurs in multiple locations (manufacturing plant, physician office, pharmacy, patient home, hospital) it is important that QA compliance is recorded by the program 110 in a continuous and transparent manner. This can be accomplished by using Biometrics for time stamped authorization/identification, along with associated data elements for each step. The duplication of this data within multiple databases 113, 114 (pharmacy information system, hospital information system, electronic medical record) in addition to the QA database 113, 114 ensures that the data is redundant and retrievable by the program 110 for longitudinal QA analysis.

In an example, if a patient and nurse offer conflicting information regarding the date/time, dosage, and type of drug administered; all relevant data can be accessed and analyzed by the program 110 in an objective and reproducible manner. Attempts to insert data “after the fact” is recorded and automatically flagged by the program 110 as a possible QA discrepancy, which mandates QA review.

Other applications, such as those disclosed in U.S. patent application Ser. Nos. 11/699,348, 11/699,349, 11/699,350, 11/699,344, 11/699,351, 11/976,518 (filed Oct. 25, 2007), and 12/010,707 filed Jan. 29, 2008, the contents of which are herein incorporated by reference in their entirety), are all complementary to the present invention in providing data for both the automated and manual forms of QA analysis by the program 110. While these Scorecards provide a quantitative measure of QA performance and patient safety; the present invention goes beyond the analytics provided within these Scorecards to provide feedback, comparative data, education, and accountability to all QA-related tasks. Some other applications provide automated QA data which can also be used for automated QA analysis by the present invention. These applications include those disclosed in U.S. patent application Ser. Nos. 11/412,884 and 12,453,268 (filed May 5, 2009), whose derived automated and objective QA data can be used in analysis of image quality, technology performance, and stakeholder compliance with established QA standards.

Another feature of the present invention includes: customization of reports based on QA profiles of participants. An example would include a clinician profile requesting all mass lesions described on a CT report have volumetric and density measurements incorporated into the report. When the radiologist issues a report with a reported mass, an automated QA prompt is presented by the program 110 to the radiologist which identifies specific report content data requested by the referring clinician. If the radiologist elects to omit this data from his/her report, the QA database 113, 114 records the omission and the referring clinician is sent an automated alert by the program 110 of the over-ride. This data would in turn be entered into the respective QA databases 113, 114 of the radiologist and clinician by the program 110 and be available for future review.

Yet another feature of the present invention includes: the ability of the program 110 to prospectively monitor “high risk” QA events, institutions, and individual personnel. As an example, a hospital has been identified as a frequent QA offender for administering improper dosage of anticoagulants, which can produce iatrogenic hemorrhage. The QA analysis performed by the program 110 shows a number of contributing factors, including insufficient education of the pharmacy staff, lack of updated software in the pharmacy information system, and understaffed nurses. As a result, the institution was placed on a “high risk” QA status by supervisory bodies (e.g., Joint Commission on the Accreditation of Healthcare Organizations (JCAHO)), along with a specific list of recommended interventions. The hospital administration which is ultimately responsible for QA compliance, staffing, education/training of pharmacy personnel and technology expenditures was placed in a QA probationary status (monitored by the program 110) by the supervisory bodies. This entails weekly QA assessment and feedback on all QA data related to the identified deficiency, along with a mandatory inspection by JCAHO staff prior to lifting of the QA probationary status.

Yet another feature of the present invention includes: automated feedback provided at the time of QA analysis by the program 110, with educational resources for QA improvement. In the example cited above (hospital with poor QA measures related to drug dosage and adverse patient outcomes), each time an anticoagulant is prescribed, a QA prompt is automatically sent by the program 110 to the ordering clinician, pharmacist, nursing staff, and patient notifying them of guidelines. All parties are also provided by the program 110 with educational resources commensurate with their education and training. For example, for the Patient: The Anticoagulation Service; for the Nurse: State Coalition for the Prevention of Medical Errors; for the Pharmacist: Anticoagulation Therapy Toolkit for Implementing the national Patient Safety Goal (CD-Rom); for the Administrator: Process Improvement Report # 29: Development of Anticoagulation Programs at 7 Medical Organizations (PDF); for the Clinician: PDA Drug Reference.

In yet another feature of the present invention, the ability to pool multiple QA databases 113, 114 and provide statistical analysis of large sample providers, is provided by the program 110. In order to detect statistically significant QA variations using the program 110, large sample size statistics are required, which can only be accomplished with the creation of standardized QA databases 113, 114. If, for example, a specific vendor's technology (e.g., CAD software for lung nodule detection) is to be included in the QA analysis, then QA data from multiple institutional users must be pooled by the program 110 in order to accurately identify QA performance.

In yet another feature of the present invention, a multi-directional QA consultation tool is provided by the program 110, where QA queries between multiple parties can be electronically transmitted and recorded within the QA databases 113, 114.

The ability to utilize the present invention as a consultation tool is particularly valuable in engaging end-users' active participation in QA analysis and improvement. As an example of how this tool would be used, the aforementioned example of a QA deficiency related to anticoagulation medications at City Hospital is used. Realizing that the QA deficiency is multi-factorial in nature, the hospital created a mandatory consultation between the ordering clinician and pharmacist each time anticoagulation medications are prescribed. In doing so, the pharmacist recognizes, using the program 110, a potential adverse drug interaction along with the potential for dietary changes in vitamin K to affect drug performance. The pharmacist alerts the ordering clinician to the potential drug interaction, makes recommendations for alternative mediation and dosage, and recommends a dietary consultation. The clinician heeds this advice, requests a dietary consultation, who adjusts the patients diet to maximize drug performance. These interventions and consultations are all captured in the QA database 113, 114 and incorporated into future QA electronic alerts, whenever other physicians place similar medication orders.

In yet another feature of the present invention, the program 110 creates an automated QA prioritization schema which can be tied to clinical outcomes. As noted above, a classification (and action) schema of QA discrepancies by the program 110 places different levels of clinical priority with each reported QA discrepancy. A QA discrepancy identified as emergent in nature (e.g., adverse drug interaction) would trigger an immediate QA warning by the program 110 to all involved parties (e.g., nurse, pharmacist, clinician, and administrator), with a recommendation to place the order on hold pending further review. Analysis of these various QA discrepancies by the program 110 is correlated with clinical data available in the EMR (e.g., discharge summary), to define the cause and effect relationship between the reported QA event and clinical outcomes. These in turn can be used to create and refine “best clinical practice” guidelines by the program 110.

In yet another feature of the present invention, creation of objective data-driven EBM guidelines based upon multi-institutional QA analysis is provided by the program 110.

In yet another feature of the present invention, development of automated, prospective QA alerts by the program 110 at the point of care, when high risk events or actions are taking place (based upon longitudinal analysis of the QA database 113, 114) is provided.

In yet another feature of the present invention, automated linkage of supportive QA data (for retrospective analysis, education, and training), which can be automatically sent to all involved parties by the program 110 in the event of an adverse outcome and/or high clinical significance QA discrepancy, is provided.

As supporting QA data (e.g., pathology or lab test results) is collected and analyzed within the QA database 113, 114 by the program 110, prior report findings can now be objectively analyzed for accuracy by the program 110 (e.g., breast micro-calcifications suspicious for cancer with recommendation for biopsy). The pathology report having established “truth”, the program 110 can send an automated link back to the radiologist who initially interpreted the mammogram study. This provides an important educational QA resource to the radiologist, who can better understand what factors contributed to his diagnostic report accuracy. By creating this linkage of supporting QA data, an iterative educational resource is created by the program 110, with the hopes of improving QA performance measures.

In yet another feature of the present invention, use of the invention to provide objective QA testing of new and/or refined technology involved in healthcare delivery is provided by the program 110. As an example, a CAD vendor is releasing a new product update for lung nodule detection. The prior product release has a well established QA profile based upon years of clinical use and comparative QA data from multiple institutional users. As the new product is introduced, the newly acquired QA data can be directly correlated by the program 110 with the prior product's performance data. This provides an objective data-driven comparative analysis of product performance, comparing the new and older versions of the CAD software. If, the new product is shown to have decreased performance for a specific application (e.g., lung nodules <5 mm in diameter), the vendor can utilize this data to enhance algorithm refinement for this specific application, and then retest the refinement using the QA database 113, 114.

The present invention serves as a tool to quantify quality performance in medical care delivery, with an emphasis on the quantitative assessment of medical documents. This QA data analysis is accomplished by the program 110 through a combination of end-user feedback, automated assessment of report content (using technologies such as natural language processing), correlation of laboratory and clinical test data with medical diagnosis and treatment planning, automated QA assessment (e.g., automated quality assurance software) and clinical outcomes analysis.

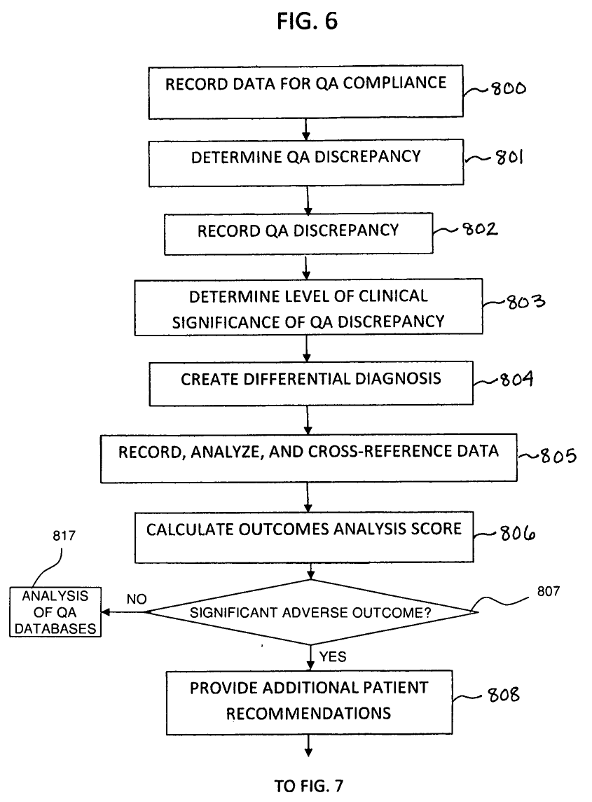

In operation of one embodiment consistent with the present invention, the program 110 records QA data for compliance in step 800 of FIG. 6.

In step 801, identification of the QA discrepancy is made by the program 110 through, for example, automated data mining using artificial intelligence (e.g., neural networks), NLP of reports, statistical analysis of clinical databases 113, 114 for outliers.

In step 802, data is recorded in the QA databases 113, 114 by the program 110 by, for example, a) type of QA discrepancy, b) date and time of occurrence, c) involved parties, d) data source, and e) technology used.

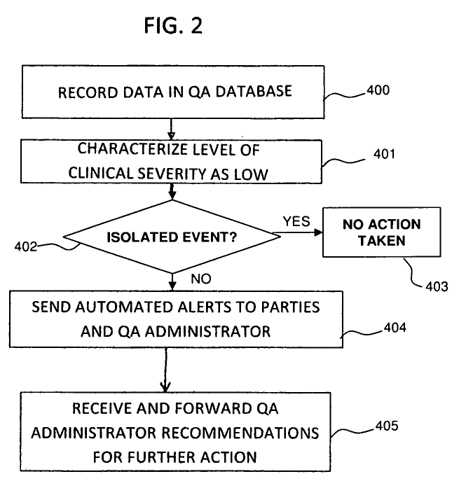

In step 803, the program 110 determines the clinical severity of the QA discrepancy, and assigns it a level or value, of for example: a) low, b) uncertain, c) moderate, d) high, and e) emergent (see FIGS. 2-5).

In step 804, the program 110 creates a differential diagnosis based on the determination of the clinical severity of the QA discrepancy, and in step 805, records all QA data in individual and collective QA databases 113, 114 and performs a meta-analysis of same, along with additional supportive data for review and analysis, in order to correlate the QA and supportive data with clinical outcomes in step 806.

Thus, in step 806 of FIG. 6, the program 110 will automatically forward said QA meta-analysis including statistical outliers, to involved parties, the QA administrator, and the QA committee for review, and determines whether or not there is an adverse outcome in step 807. If there is no significant adverse outcome, then the program 110 proceeds to a meta-analysis of the pooled QA databases 113, 114 in step 817.

If the program 110 determines if there is an adverse outcome, in step 808, the program 110 determines whether the outcome is intermediate (i.e., prolonged hospital stay by one (1) day), or highly significant. If intermediate, then the program 110 notifies the user, for example, that the patient should stay longer in the hospital, or if highly significant, the program 110 notifies the user, for example, that the patient should be transferred, for example, to the intensive care unit (i.e., providing additional patient recommendations).

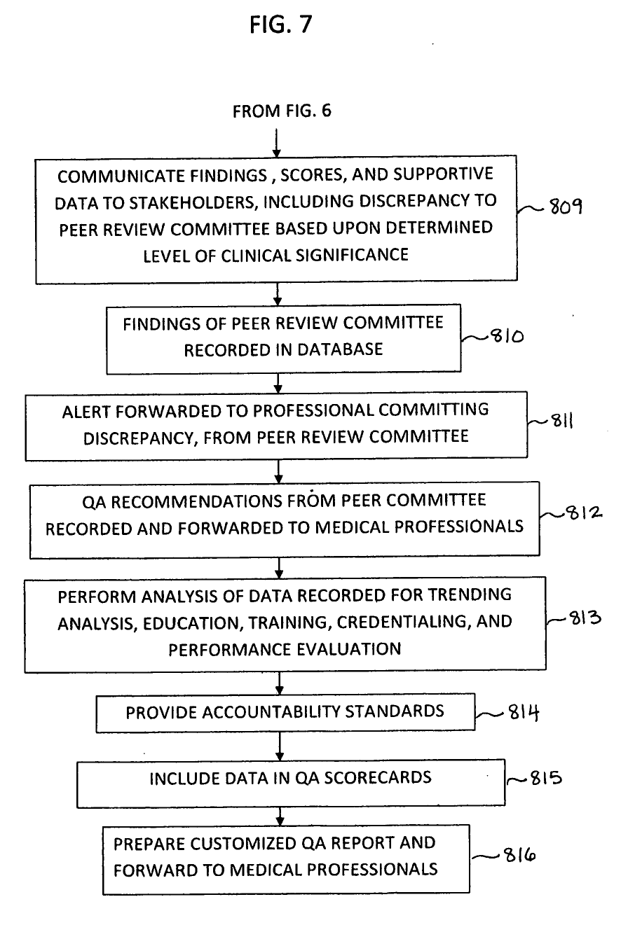

In step 809 (see FIG. 7), the program 110 will automatically communicate its findings, clinical severity values, quality assurance scores (from Scorecards), and supportive data to stakeholders, including triggering a review by a QA multi-disciplinary committee with recommended action based upon the level of clinical significance of the QA discrepancy.

In step 810, the program 110 will record the recommendations made by the QA committee for intervention (e.g., remedial education, probation, adjustment of credentials).

In step 811, the program 110 will forward an alert with the recommendations from the peer review committee, to the medical professional committing the QA discrepancy.

In step 812, the QA recommendations from the peer review committee are recorded and forwarded to the stakeholders and other medical professionals by the program 110.

In step 813, the program 110 will perform an analysis of the data recorded for trending analysis, education, training, credentialing, and performance evaluation of the medical professionals.

In step 814, the program 110 will provide accountability standards for future use by the medical professionals and institutions.

In step 815, the program 110 will include data in the QA Scorecards for trending analysis etc.

Finally, in step 816, the program 110 will prepare a customized QA report which is forwarded to the medical professionals.

The overall workflow of the present invention accounts for QA data acquisition (i.e., data input), archival (i.e., storage in standardized QA databases), analysis (i.e., cross-referencing of QA data and correlating with established medical standards), feedback (i.e., automated alerts sent to involved stakeholders notifying them of QA outliers), and intervention (i.e., recommendations for safeguards to prevent future adverse events, requirements for additional end-user education/training, prospective QA monitoring, and technology adoption). The creation of standardized QA databases 113, 114 by the program 110, identification of contributing factors (which play a contributory role to the identified QA discrepancy), and ability to prospectively cross-correlate these QA data analytics by the program 110 with reference peer groups and established standards creates education and accountability measures currently not available in medical practice.

The mandated QA actions issued by the QA multi-disciplinary committee and QA administrator can be analyzed by the program 110 to determine which actions are best suited (given the type, frequency, nature of the QA discrepancy) for different types of end-users. The ultimate goal is to create an environment of QA accountability, based upon objective data analysis, which in turn can be used to create EBM guidelines for optimal medical practice.

Thus, it should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A computer-implemented method of an automated medical quality assurance, comprising:
storing quality assurance data and supportive data in at least one database;
identifying a quality assurance discrepancy from said quality assurance data;
assigning a level of clinical severity, to said quality assurance discrepancy;
creating an automated differential diagnosis based on said level of said clinical severity, to determine clinical outcomes; and
analyzing said quality assurance data and correlating said analysis of said quality assurance data with said stored supportive data and said clinical outcomes.

2. The method according to claim 1, further comprising:
forwarding said analysis of said quality assurance data to involved parties, including a quality assurance committee; and
determining whether an adverse outcome is present, based on said quality assurance analysis and correlation.

3. The method according to claim 2, wherein when said adverse outcome is not present, then a meta-analysis of all quality assurance databases is performed.

4. The method according to claim 1, wherein the identifying step includes at least one of data mining of said quality assurance data using artificial intelligence, a natural language processing of reports, and a statistical analysis of clinical databases for a determination of quality assurance outliers.

5. The method according to claim 1, wherein said storing step includes recording at least one of a type of quality assurance discrepancy, a date and time of occurrence of said quality assurance discrepancy, names of involved parties, a source of said quality assurance data, and a technology used.

6. The method according to claim 1, wherein said level of said clinical severity is assigned as one of low, uncertain, moderate, high, and emergent.

7. The method according to claim 2, wherein when said adverse outcome is determined, said adverse outcome is determined as one of intermediate or highly significant.

8. The method according to claim 7, wherein said adverse outcome includes additional patient recommendations, including a prolonged hospital stay in an intermediate adverse outcome, or including a transfer to an intensive care unit in a highly significant adverse outcome.

9. The method according to claim 8, wherein when said adverse outcome is determined, said adverse outcome, its findings, said clinical severity values, quality assurance scores, and said supportive data, are automatically communicated to stakeholders.

10. The method according to claim 9, further comprising:
triggering a review by said quality assurance committee, based upon said level of clinical severity of said quality assurance discrepancy in said adverse outcome.

11. The method according to claim 10, further comprising:
storing said recommended actions made by said quality assurance committee for intervention, including at least one of remedial education, probation, or adjustment of credentials.

12. The method according to claim 11, further comprising:
forwarding an alert with said recommended actions from said quality assurance committee, to a medical professional committing said quality assurance discrepancy.

13. The method according to claim 12, further comprising:
storing said recommended actions from said quality assurance committee; and
forwarding said recommended actions to at least said stakeholders and medical professionals.

14. The method according to claim 13, further comprising:
performing an analysis of said quality assurance data for trending analysis, education, training, credentialing, and performance evaluation of said medical professionals.

15. The method according to claim 14, further comprising:
providing accountability standards for use by said medical professionals and institutions.

16. The method according to claim 15, further comprising:
including said quality assurance data in quality assurance Scorecards for at least trending analysis.

17. The method according to claim 14, further comprising:
preparing a customized quality assurance report which is forwarded to said medical professionals.

18. The method according to claim 17, wherein said quality assurance report includes at least one of: quality assurance standards; an objective analysis in establishment of “truth”; routine bidirectional feedback; multi-directional accountability; integration of multiple data elements; and context and user-specific longitudinal analysis.

19. The method according to claim 1, wherein said quality assurance discrepancies include at least one of complacency; faulty reasoning; lack of knowledge; perceptual error; communication error; technical error; complications; and inattention.

20. The method according to claim 1, wherein said supportive quality assurance data includes at least one of historical imaging reports; clinical test data; laboratory and pathology data; patient history and physical data; consultation notes; discharge summary; quality assurance Scorecard databases; evidence-based medicine (EBM) guidelines; documented adverse outcomes; or automated decision support systems.

21. The method according to claim 1, wherein said identifying step includes:
identifying a quality assurance discrepancy using an automated CAD analysis;
providing quantitative and qualitative analysis of any findings; and
utilizing natural language processing tools to analyze retrospective and prospective imaging reports to identify a presence of a pathologic finding.

22. The method according to claim 4, wherein at least one of a source of a potential quality assurance discrepancy, a finding in question, a clinical significance of said potential quality assurance discrepancy, identifying data of quality assurance report authors, and computer-derived quantitative/qualitative measures, are stored in said quality assurance database.

23. The method according to claim 1, wherein said automated differential diagnosis is based on patient medical history, laboratory data, and ancillary clinical tests.

24. The method according to claim 6, wherein in a low level of clinical severity, no further action is required if said quality assurance discrepancy is an isolated event.

25. The method according to claim 6, wherein in a low level of clinical severity, automated quality assurance alerts are send to involved parties if said quality assurance discrepancy is a repetitive problem.

26. The method according to claim 6, wherein in an uncertain level of clinical severity, a clinical significance of said quality assurance data is established and a pathway of corresponding level of clinical severity is taken.

27. The method according to claim 26, wherein when said clinical significance remains uncertain, then future analysis is performed on said quality assurance database, and an alert is sent to a quality assurance professional for follow-up.

28. The method according to claim 27, wherein clinical databases are mined for a determination of said level of clinical severity, and once said level of clinical severity is established, said pathway of corresponding level of clinical severity is taken.

29. The method according to claim 6, wherein in a moderate level of clinical severity, automated quality assurance alerts are sent to involved parties for mandatory follow-up and documented in said quality assurance database, and a response from said involved parties is documented and sent to a quality assurance professional for review.

30. The method according to claim 29,
wherein when follow-up by said involved parties is sufficient, no further action is taken; and
wherein when follow-up by said involved parties is insufficient, further analysis of said quality assurance data is forwarded to a quality assurance professional for review.

31. The method according to claim 30, wherein when said quality assurance professional determines further action is required, a quality assurance committee is notified and recommends additional action which is forwarded to said involved parties and stored in said database.

32. The method according to claim 6, wherein in a high or emergent level of clinical severity, automated quality assurance alerts are sent to all involved parties, and immediate action and a formal response are requested.

33. The method according to claim 32, wherein a quality assurance committee reviews said quality assurance discrepancy and makes recommendations on actions to be taken, said actions which are tracked by a quality assurance professional for compliance.

34. The method according to claim 33, wherein when said actions are non-compliant, said quality assurance committee again reviews said actions for further follow-up, and said clinical outcomes are recorded and correlated with said quality assurance discrepancy and said actions taken.

35. The method according to claim 1, further comprising:
pooling multiple quality assurance databases to provide a statistical analysis of quality assurance variations.
